(19) United States
(12) Patent Application Publication
(10) Pub. No.: US 2007/0041763 A1
(43) Pub. Date: Feb. 22, 2007

(54) Sheet cassette

(75) Inventor: Shinsaku Yoneda, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/504,171

(22) Filed: Aug. 15, 2006

(30) Foreign Application Priority Data
Aug. 19, 2005 (JP) 2005-239107

(51) Int. Cl. G03G 15/00

(52) U.S. Cl. 399/393

(57) ABSTRACT

A sheet cassette is provided with a sheet accommodating portion capable of accommodating a plurality of sizes of sheets, a side-fence member movable in conformity with the size of sheets to be accommodated into the sheet accommodating portion so as to be brought into contact with the sheets at a specified side, and a position defining portion for defining an arranged position of the side-fence member in correspondence with the size of the sheets. The position defining portion includes at least a first size display section having indices set based on a first index criterion, and a second size display section having indices set based on a second index criterion different from the first index criterion. The side-fence member includes a first pointer for indicating the indices of the first size display section and a second pointer for indicating the indices of the second size display section.

### BACKGROUND OF THE INVENTION

1. Field of the Invention

The present invention relates to a sheet cassette and particularly to a sheet cassette to be mounted into an image forming apparatus such as a copier or a printer, and an image forming apparatus provided with such a sheet cassette.

2. Description of the Related Art

There have been conventionally known sheet cassettes to be mounted in image forming apparatuses such as copiers and printers (see, for example, Japanese Unexamined Patent Publication No. H07-117863). Such a sheet cassette is so constructed as to be able to accommodate a plurality of sizes of sheets (recording sheets) and has a function of supplying the accommodated sheets to an image forming unit of an image forming apparatus. Upon replenishing (accommodating) the sheet cassette with sheets, a side-fence member in the sheet cassette is slid to a specified position before the replenishment of sheets, thereby defining, in the sheet cassette, a specified area (width) corresponding to the size of sheets to be replenished. Since the side-fence member is held in contact with the sheets accommodated into the sheet cassette through this preprocessing, the sheets can be fed to the image forming unit in a main body of the image forming apparatus while being securely guided by the side-fence member. In this way, an occurrence of a problem such as an image displacement during the image formation is suppressed.

Further, the sheet cassette is provided with an indicator as a function of (means for) easily arranging the side-fence member at the specified position corresponding to the size of the sheets to be replenished. On this indicator, a plurality of indices based on various different unit systems (index criteria) such as an inch system and a centimeter system for indicating standardized sheet sizes are displayed in a mixed manner in the same row. The side-fence member can be arranged at a desired position by being adjusted to a given index on the indicator.

There has been also known a technique of recessing portions of a side-fence member corresponding to indices of an indicator, thereby facilitating an adjustment of the side-fence member to an index of the indicator.

However, the indicators of the conventional sheet cassettes as described above have an inconvenience of narrowing intervals between indices on the indicator since the indices based on the centimeter system and those based on the inch system are arranged in a mixed manner on the same row. Particularly, there is an inconvenience that an interval between a display position of A4 size (210 mm) index based on the centimeter system and that of 8.5×11 size (215.9 mm) index based on the inch system is quite narrow. This makes it difficult to precisely adjust the position of the side-fence member to a desired index position, thereby leading to a problem that the side-fence member may be set at a position different from the one corresponding to sheets to be accommodated into a sheet accommodating portion in some cases.

### SUMMARY OF THE INVENTION

An object of the present invention is to provide a sheet cassette capable of precisely adjusting the position of a side-fence member to a desired index position and an image forming apparatus provided with such a sheet cassette.

One aspect of the present invention is directed to a sheet cassette, comprising a sheet accommodating portion capable of accommodating a plurality of sizes of sheets; a side-fence member movable in conformity with the size of sheets to be accommodated into the sheet accommodating portion so as to be brought into contact with the sheets at a specified side; and a position defining portion for defining an arranged position of the side-fence member in correspondence with the size of the sheets, the position defining portion including at least a first size display section having indices set based on a first index criterion, the first and second size display sections being arranged at different positions, and a second size display section having indices set based on a second index criterion different from the first index criterion, and the side-fence member including a first pointer for indicating the indices of the first size display section and a second pointer for indicating the indices of the second size display section.

### BRIEF DESCRIPTION OF THE DRAWINGS

FIG. 1 is a perspective view showing one exemplary entire construction of a copier in which sheet cassettes according to one embodiment of the invention are mounted.

FIG. 2 is a section schematically showing the internal construction of the copier shown in FIG. 1.

FIG. 3 is a block diagram showing the electrical construction of the copier shown in FIG. 2.

FIG. 4 is a perspective view showing one exemplary sheet cassette according to the embodiment shown in FIG. 1.

FIG. 5 is a plan view of the sheet cassette shown in FIG. 4.

FIG. 6 is an enlarged view showing one example of a peripheral portion of a position defining portion of the sheet cassette shown in FIG. 5.

FIG. 7 is an enlarged view showing a state reached by moving a side-fence member in the sheet cassette shown in FIG. 6.

### DETAILED DESCRIPTION OF THE PREFERRED EMBODIMENTS

Hereinafter, one embodiment of the present invention is described with reference to the accompanying drawings.

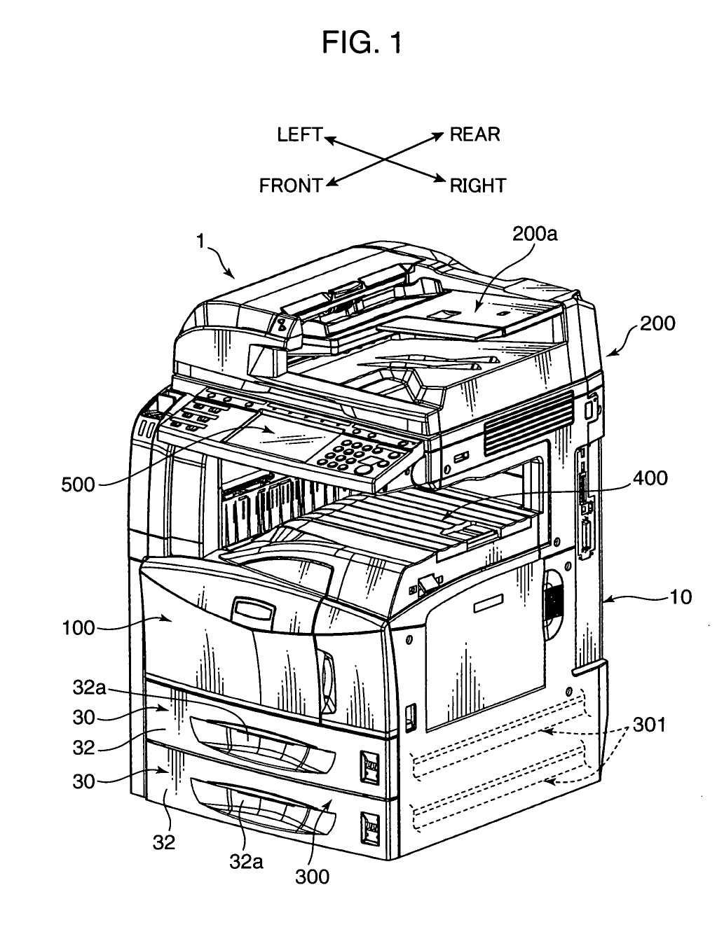

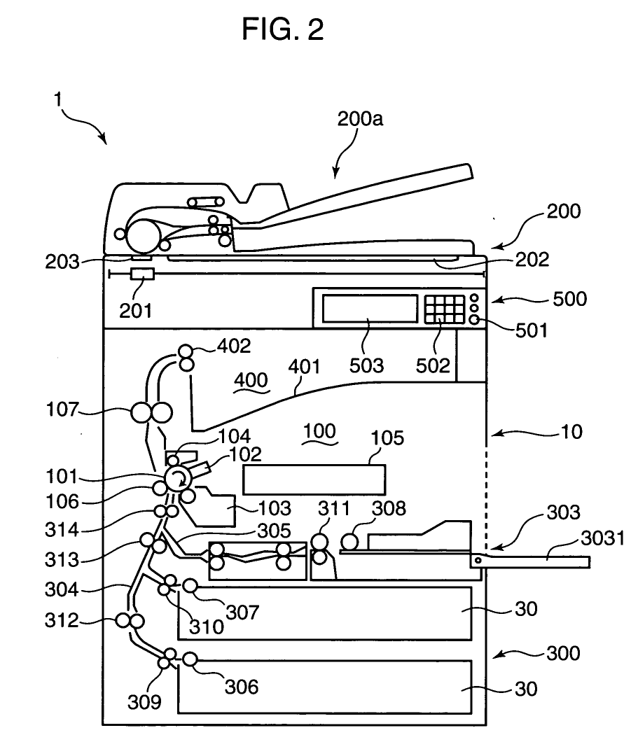

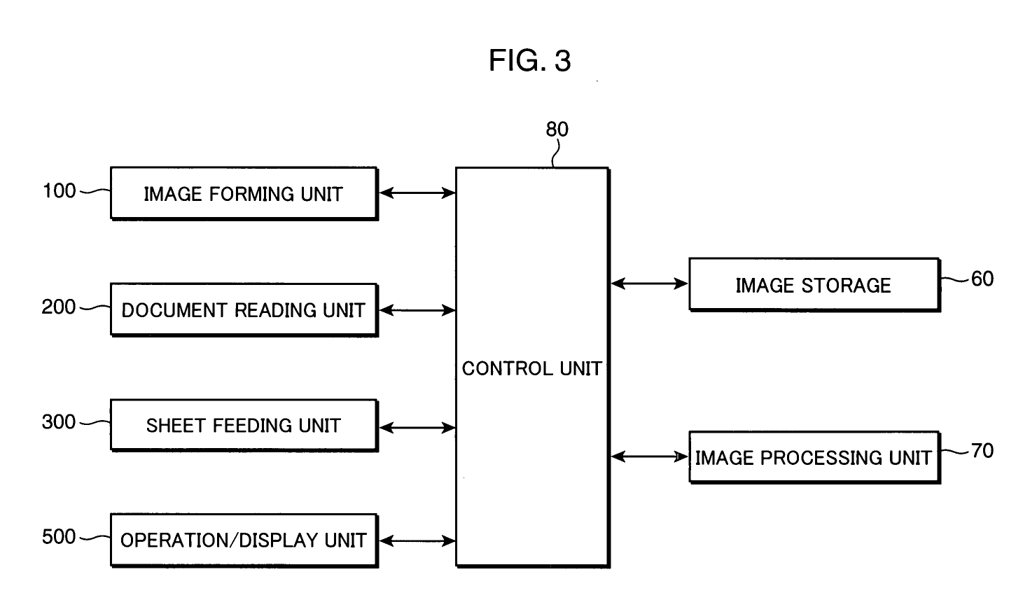

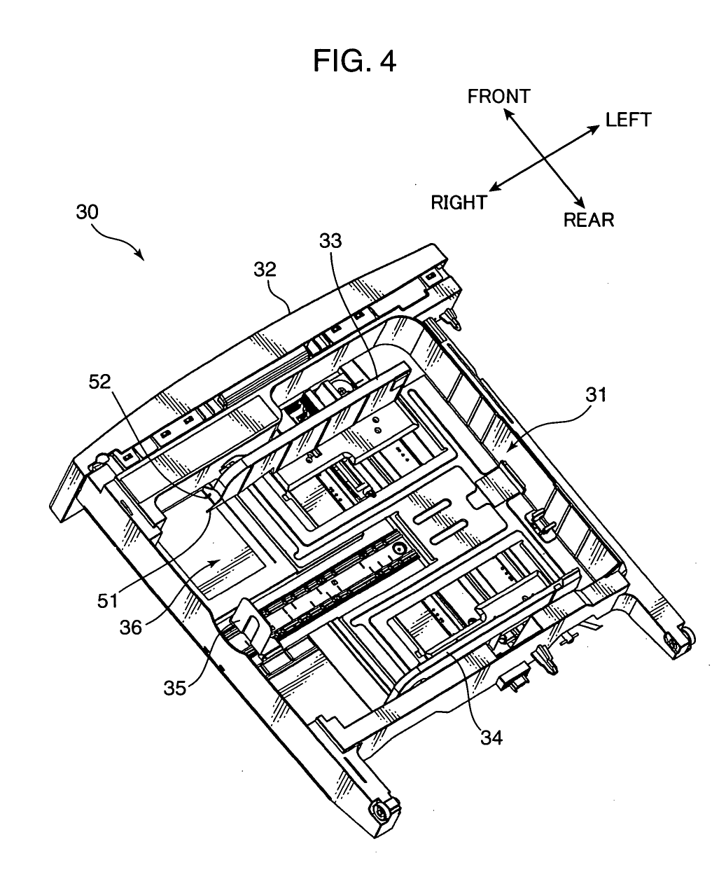

FIG. 1 is a perspective view showing one exemplary entire construction of a copier in which sheet cassettes according to one embodiment of the invention are mounted, FIG. 2 is a section schematically showing the internal construction of the copier shown in FIG. 1, and FIG. 3 is a block diagram showing the electrical construction of the copier shown in FIG. 2. Further, FIGS. 4 to 7 are views showing the detailed construction of the sheet cassette shown in FIG. 1. First, with reference to FIGS. 1 to 3, the construction of a copier 1 in which sheet cassettes 30 of this embodiment are mounted is described.

As shown in FIGS. 1 and 2, the copier 1 is provided with an image forming unit 100, a document reading unit 200 provided atop a main body 10 including the image forming unit 100, a sheet feeding unit 300 provided at a lower part of the main body 10, an internal discharging portion 400 disposed substantially in the center of the main body 10, and an operation/display unit 500 disposed at a front part of the main body 10.

The document reading unit 200 is for reading an image of a document and generating an image data corresponding to the document. The document reading unit 200 includes a document feeder 200a (ADF: automatic document feeder) arranged at an upper side, a scanner 201 having a CCD (charge coupled device) sensor for generating an image data from an optically read image of a document, an exposure lamp, and the like a first platen glass 202 used to read an image of a document set in the apparatus and a second platen glass 203 used to read an image of a document set in the ADF. The document reading unit 200 outputs an image data obtained to a control unit 80 to be described later while scanning a document placed on the first platen glass 202 or conveyed (moved) in contact with the second platen glass 203 by the document feeder 200a.

The document feeder 200a is for automatically feeding documents to the document reading unit 200 (document reading position on the second platen glass 203). The document feeder 200a pivots with respect to the upper surface of the main body 10 (document reading unit 200), for example, with one end of the rear surface of the apparatus as a pivoting point. A user can place a document to be read such as an open book on the upper surface of the first platen glass 202 by lifting the document feeder 200a upward and rearward in such a manner as to open the upper surfaces of the first and second platen glasses 202, 203.

The sheet feeding unit 300 is for feeding sheets to the image forming unit 100. The sheet feeding unit 300 includes, for example, a pair of upper and lower sheet feeding cassettes 30 in which sheets (recording sheets) of various sizes are accommodated, and a manual sheet feeder 303 having a manual feed tray 3031 constructed to be free to make opening and closing movements with respect to one side wall of the main body 10. The sheet feeding unit 300 also includes a conveyance path 304 for conveying sheets from the respective sheet feeding cassettes 30 to the image forming unit 100, and a conveyance path 305 for conveying sheets from the manual sheet feeder 303 to the image forming unit 100. The respective sheet feeding cassettes 30 and the manual sheet feeder 303 have pickup rollers 306 to 308 for dispensing the accommodated sheets, and feed rollers 309 to 311 for feeding the sheets one by one to the respective conveyance paths. Conveyance rollers 312, 313 for conveying sheets, registration rollers 314 for letting the sheet being conveyed wait in standby before the image forming unit 100 and the like are disposed on the conveyance path 304. It should be noted that the conveyance path 305 joins the conveyance path 304 at a position upstream of the registration rollers 314.

The image forming unit 100 is for forming (printing) a specified image on a sheet conveyed by the sheet feeding unit 300 based on an image data obtained by reading a document by means of the document reading unit 200. The image forming unit 100 includes a photoconductive drum 101 supported rotatably in a direction of arrow shown in FIG. 2, a charger 102, a developing device 103, a cleaning device 104, a laser scanning unit 105, and a transfer roller 106, the devices 102 to 106 being disposed around the photoconductive drum 101, and fixing rollers 107 disposed downstream of the transfer roller 106.

The charger 102 is for uniformly charging the outer surface of the photoconductive drum 101 at a specified potential. The laser scanning unit 105 is for illuminating the outer surface of the photoconductive drum 101 with a laser beam based on an image data transmitted from an image storage 60 to be described later or the like, thereby forming an electrostatic latent image on the outer surface of the photoconductive drum 101. The developing device 103 is for developing the image (document image) by attaching toner to the electrostatic latent image. The transfer roller 106 is for transferring the developed toner image on the photoconductive drum 101 to a conveyed sheet while pressing the sheet against the photoconductive drum 101. The fixing rollers 107 are for fixing the transferred toner image to the sheet. The fixing rollers are comprised of unillustrated heating roller and pressure roller, wherein the toner on the sheet is fused by heat given from the heating roller and pressed by the pressure roller to be fixed onto the sheet. The cleaning device 104 is for cleaning the toner residual on the outer surface of the photoconductive drum 101 after the transfer of the image to the sheet is completed.

The internal discharging portion 400 is adapted for receiving the sheet having the image formed thereon by the image forming unit 100. The internal discharging unit 400 includes a discharge tray 401 and a discharge roller 402 and discharges the sheet conveyed from the fixing roller 107 onto the discharge tray 401 by means of the discharge roller 402. Since the copier 1 is provided with the internal discharging unit 400 and constructed to discharge the sheet onto the discharge tray 401 as described above, the copier 1 can be downsized and an installation space therefor can be made smaller as compared to a case where a discharge tray is provided at a side wall portion and sheets are discharged thereon.

The operation/display unit 500 is for entering a specified instruction through an operation of the user. The operation/display unit 500 includes a start key 501 used by the user to enter a print instruction, a numeric keypad 502 used for entering the number of sets to be printed and other numbers, and a display device 503 (display) such as a liquid crystal display (LCD) for displaying pieces of operation guiding information for the entry of setting various copying operations, and various operation buttons and the like.

FIG. 3 is a block diagram showing the electrical construction of the copier 1 shown in FIG. 2. The copier 1 is provided with the control unit 80 for governing the operation of the entire apparatus. The control unit 80 includes a ROM (read only memory) for storing a control program of the copier 1, a RAM (random access memory) for temporarily storing data, and a microcomputer for reading the control program and the like from the ROM and executing it, and is adapted to control the entire apparatus in accordance with specified instruction information entered by means of the operation/display unit 500, and detection signals from various sensors disposed at positions in the apparatus. The image forming unit 100, the document reading unit 200, the sheet feeding unit 300, the operation/display unit 500, the image storage 60, an image processing unit 70 and the like are connected with the control unit 80.

The image storage 60 is a memory for temporarily storing an image data of a document read by the document reading unit 200, and an image data transmitted from an external apparatus via an unillustrated network interface or the like.

The image processing unit 70 is for applying various image processings such as a gamma processing and enlargement/reduction processing to the image data. In the image processing unit 70, an image data obtained, for example, by the document reading unit 200 is A/D converted, and various image processings are applied to the digital image data after the A/D conversion.

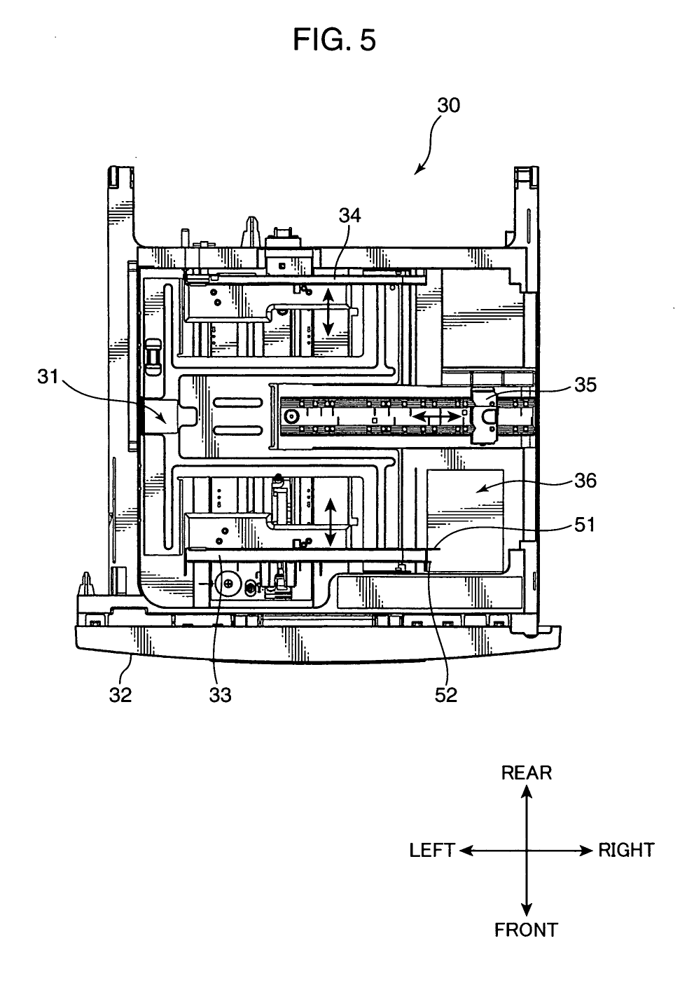

Here, the sheet cassettes 30 according to this embodiment are described. Each of the pair of sheet cassettes 30 is constructed to be slidable between an accommodated position (see FIG. 1) where the sheet cassette 30 is accommodated in the main body 10 of the copier 1 and a withdrawn position where the sheet cassette 30 is withdrawn forward from the main body 10 of the copier 1. Specifically, rails 301 (e.g. guide rails) for slidably supporting the sheet cassettes 30 are mounted in the main body 10 of the copier 1, and the left and right outer side portions of the sheet cassettes 30 are configured to be engageable with (slidable along) the rails 301. As shown in FIGS. 4 and 5, each sheet cassette 30 includes a sheet accommodating portion 31 capable of accommodating sheets of a plurality of sizes, and a front cover 32 provided before the sheet accommodating portion 31 and having a grip 32a (see FIG. 1) to be gripped upon sliding the sheet cassette 30 relative to the main body 10 of the copier 1.

The sheet accommodating portion 31 is in the form of such a recess that a plurality of sheets can be accommodated while being stacked therein, and a pair of side-fence members 33, 34 in the form of flat plates, a guiding member 35 and an indicator 36 are provided on the inner bottom surface of the sheet accommodating portion 31. It should be noted that the indicator 36 is one example of a “position defining portion” of the present invention. The side-fence members 33 and 34 in the form of flat plates stand at front and rear sides in the sheet accommodating portion 31 such that the plate surfaces thereof face each other, and are constructed to be slidable together. Specifically, the side-fence member 34 moves forward when the side-fence member 33 is moved backward, whereas the side-fence member 34 moves backward when the side-fence member 33 is moved forward. These side-fence members 33, 34 have the arranged positions thereof defined beforehand in such a manner as to be held in contact with a pair of opposite sides of the sheets to be accommodated into the sheet accommodating portion 31, thereby having a function of being brought into contact with the sheets from front and behind to define the front and rear end positions of the sheets when the sheets are accommodated (replenished).

As shown in FIG. 5, the guiding member 35 is so arranged at a position rightward from the center of the sheet accommodating portion 31 as to be slidable along transverse direction or right and left direction in the sheet accommodating portion 31. This guiding member 35 has a function of defining transverse positions of sheets accommodated into the sheet accommodating portion 31 by coming into contact with the sheets from right. In other words, the sheets accommodated in the sheet accommodating portion 31 are fixedly positioned at four sides by an inner wall of the sheet accommodating portion 31, a pair of side-fence members 33, 34 and the guiding member 35.

The indicator 36 is provided to define the arranged position of the side-fence member 33 at the front side in the sheet accommodating portion 31 in correspondence with the size of the sheets to be accommodated in the sheet accommodating portion 31. As shown in FIG. 5, this indicator 36 is provided at a right front side in the sheet accommodating portion 31, i.e. outside a movable range of the side-fence member 33.

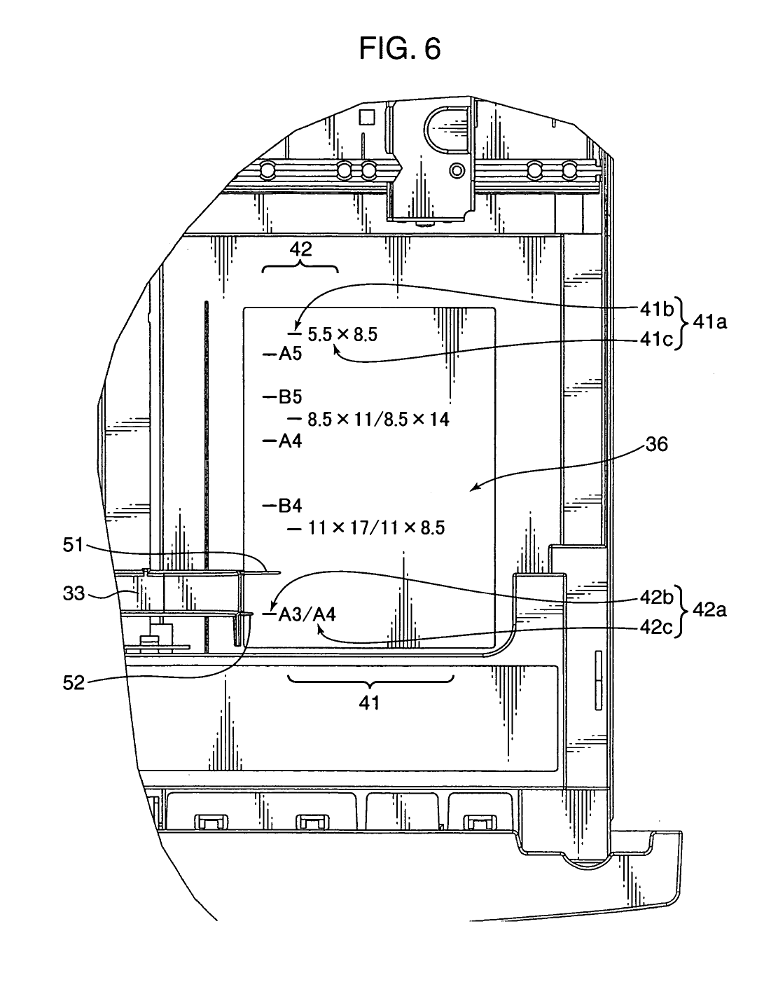

In this embodiment, the indicator 36 includes an inch-size display section 41 and a centimeter-size display section 42 formed at different positions (areas) with respect to transverse direction as shown in FIG. 6. It should be noted that the inch-size display section 41 and the centimeter-size display section 42 are respectively examples of a “first size display section” and a “second size display section” of the present invention. More specifically, display areas of the inch-size display section 41 and the centimeter-size display section 42 partly overlap, but the centimeter-size display section 42 is located at a position closer to the movable range of the side-fence member 33 as compared to the inch-size display section 41.

The inch-size display section 41 has a plurality of indices 41a set based on the inch system (first index criterion) which is an index criterion, wherein each index 41a includes a marking section 41b that substantially serves as a marking for the side-fence member 33 upon defining the arranged position, and a display portion 41c describing a specific size at this marking portion 41b. Examples of the index 41a include 5.5×8.5 size (139.7 mm), 8.5×11 size (215.9 mm), 8.5×14 size (215.9 mm), 11×17 size (279.4 mm) and 11×8.5 size (279.4 mm).

The centimeter-size display section 42 has a plurality of indices 42a set based on the centimeter system (second index criterion) which is an index criterion, wherein each index 42a includes a marking section 42b that substantially serves as a marking for the side-fence member 33 upon defining the arranged position, and a display portion 42c describing a specific size corresponding to this marking portion 42b. Examples of the index 42a include A5 size (148 mm), B5 size (182 mm), horizontal A4 size (210 mm), B4 size (257 mm) and A3/vertical A4 size (297 mm).

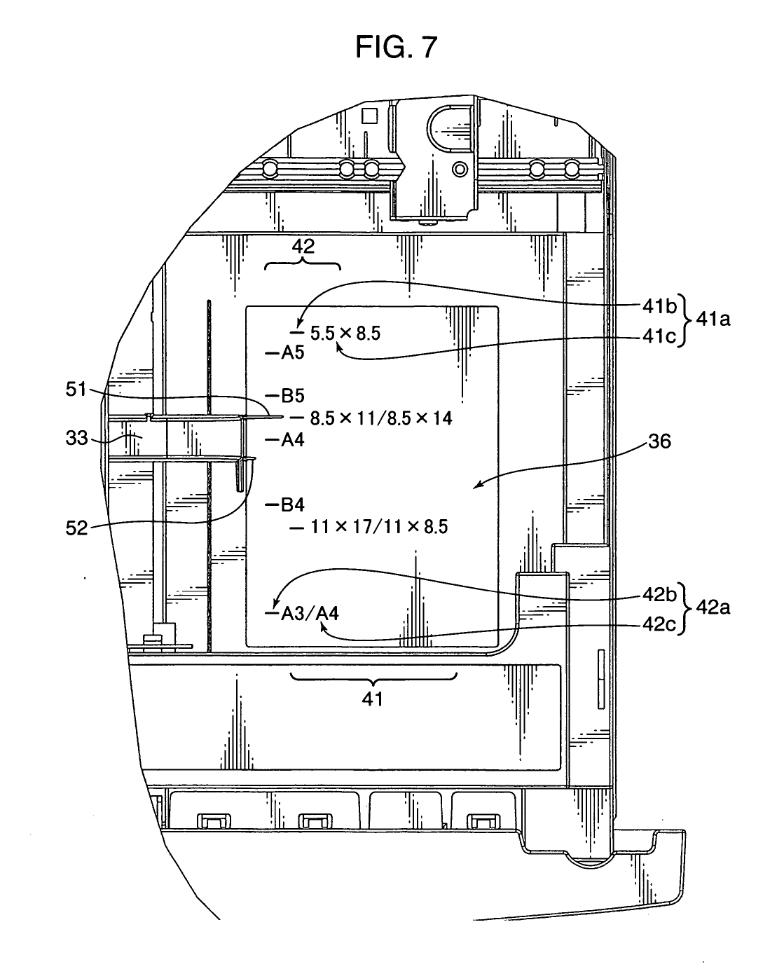

Further, in this embodiment, an inch index pointer 51 and a centimeter index pointer 52 are provided at an end of the side-fence member 33 toward the indicator 36 as shown in FIGS. 4 and 5. It should be noted that the inch index pointer 51 and the centimeter index pointer 52 are examples of a “first pointer” and a “second pointer” of the present invention. As shown in FIG. 7, the inch index pointer 51 projects by a specified amount toward the indicator 36 from an end of the rear surface of the side-fence member 33 so as to be able to point the marking portions 41b of the respective indices 41a of the inch-size display section 41 of the indicator 36 as the side-fence member 33 is slid in forward and backward directions.

Further, as shown in FIG. 6, the centimeter index pointer 52 projects by an amount, which is different from the projecting amount of the inch index pointer 51, toward the indicator 36 from an end of the front surface of the side-fence member 33 so as to be able to point the marking portions 42b of the respective indices 42a of the centimeter-size display section 42 of the indictor 36 as the side-fence member 33 is slid in forward and backward directions. Since the centimeter-size display section 42 is arranged at the position closer to the side-fence member 33 than the inch-size display section 41 in this embodiment, the projecting amount of the inch index pointer 51 is set to be larger than that of the centimeter index pointer 52.

The centimeter index pointer 52 is arranged at a position spaced forward from the inch index pointer 51 by a specified distance (as much as the thickness of the side-fence member 33 in forward and backward directions). Thus, the respective size display sections 41, 42 can be pointed by the inch index pointer 51 and the centimeter index pointer 52 projecting rightward while being spaced apart by the specified distance. Therefore, it is possible to arrange the centimeter-size display section 42 while displacing it forward by as much as the thickness of the side-fence member 33 relative to the inch-size display section 41.

As described above, the inch index pointer 51 and the centimeter index pointer 52 are disposed at the end positions of the side-fence member 33 toward the indicator 36. Here, they are disposed at the positions at the end of the side-fence member 33 in a moving direction of the side-fence member 33 and at ends of the side-fence member 33 in a direction normal to the moving direction, i.e. they are disposed at the respective corner positions of one end of the side-fence member 33. However, the disposed positions are not limited to these positions. In short, any disposed position will do provided that the inch index pointer 51 and the centimeter index pointer 52 are spaced by the specified distance in the moving direction and are so disposed at the end of the side-fence member 33 as to project by different amounts in the direction (rightward direction) perpendicular to the moving direction of the side-fence member 33.

Next, upon replenishing the sheet cassette 30 of this embodiment with sheets (recording sheets), the grip 32a provided on the front cover 32 of the sheet cassette 30 is gripped and pulled forward, whereby the sheet cassette 30 is withdrawn from the main body 10 of the copier 1. In this way, the sheet accommodating portion 31 of the sheet cassette 30 is exposed to the outside.

For example, in the case of replenishing the sheet cassette 30 with sheets of A4 size, the side-fence member 33 is slid to align the leading end of the centimeter index pointer 52 of the side-fence member 33 with the marking portion 42b of the index 42a having the display portion 42c “A4” in the centimeter-size display section 42 of the indicator 36 as shown in FIG. 6. As a result, the side-fence member 33 comes to be located at a position corresponding to the size (A4 size) of sheets to be accommodated into the sheet accommodating portion 31. At this time, the side-fence member 34 slides in a specified direction as the side-fence member 33 is moved. In this way, a sheet accommodating area having a specified width (in this case, the longitudinal length of A4 size sheets: 297 mm) is defined by the pair of side-fence members 33, 34.

For example, in the case of replenishing the sheet cassette 30 with sheets of 8.5×11 size, the side-fence member 33 is slid to align the leading end of the inch index pointer 51 of the side-fence member 33 with the marking portion 41b of the index 41a having the display portion 41c “8.5×11” in the inch-size display section 41 of the indicator 36 as shown in FIG. 7. As a result, the side-fence member 33 comes to be located at a position corresponding to the size (8.5×11 size) of sheets to be accommodated into the sheet accommodating portion 31. At this time, the side-fence member 34 slides in a specified direction as the side-fence member 33 is moved. In this way, a sheet accommodating area having a specified with (in this case, the longitudinal length of 8.5×11 size sheets: 215.9 mm) is defined by the pair of side-fence members 33, 34.

Preferably, the guiding member 35 of the sheet accommodating portion 31 is automatically or manually set at a position corresponding to the sheet size (A4 size and 8.5×11 size) when the side-fence members 33 and 34 are moved.

The sheets accommodated into the sheet accommodating portion 31 in this way are accommodated within an area defined by the left inner wall surface of the sheet accommodating portion 31, the pair of side-fence members 33, 34 and the guiding member 35 without being displaced. Then, when an instruction to start copying is given in the operation/display unit 500 after the sheet cassette 30 is accommodated into the main body 10 of the copier 1 by a user, the sheets in the sheet accommodating portion 31 are successively conveyed toward the image forming unit 100 without being displaced while being securely guided by the pair of side-fence members 33, 34.

In this embodiment, the inch-size display section 41 having the indices 41a set based on the inch system and the centimeter-size display section 42 having the indices 42a set based on the centimeter system are arranged at different positions as described above. The indices 41a are pointed by the inch index pointer 51 of the side-fence member 33, whereas the indices 42a are pointed by the centimeter index pointer 52 of the side-fence member 33. By this construction, the inch index pointer 51 of the side-fence member 33 points only the inch-size display section 41, and the centimeter index pointer 52 of the side-fence member 33 points only the centimeter-size display section 42. Accordingly, even if values (sizes) indicated by the respective indices set based on different index criteria are relatively close and these indices are arranged at proximate positions on the indicator 36, pointing of the indices 42a, 41a of the unrelated size display sections by the respective pointers 51, 52 of the side-fence member 33 against intention can be suppressed. Thus, it can be suppressed to set the side-fence member 33 at a position different from the one corresponding to the size of sheets to be accommodated into the sheet accommodating portion 31.

Further in this embodiment, the centimeter index pointer 52 is disposed at the end position of the side-fence member 33 with respect to the direction normal to the moving direction of the side-fence member 33, the end position being spaced forward (moving direction of the side-fence member 33) by the specified distance (e.g. as much as the thickness of the side-fence member 33 in forward and backward directions) from the inch index pointer 51 as described above, whereby the inch index pointer 51 and the centimeter index pointer 52 can be let to point the respective size display sections 41, 42 while projecting rightward and being spaced apart by the specified distance. Thus, the centimeter-size display section 42 can be arranged while being displaced forward by as much as the thickness of the side-fence member 33 relative to the inch-size display section 41. This enables the indices to be arranged at distanced positions on the indicator 36 even if the values (sheet sizes) indicated by the respective indices set based on the different index criteria are relatively close. In other words, the marking portion 41b of the index 41a of 8.5×11 size (215.9 mm) in the inch-size display section 41 and the marking portion 42b of the index 42a of A4 size (210 mm) in the centimeter-size display section 42 can be arranged at distanced positions on the indicator 36 (arranged while being displaced in the moving direction of the side-fence member 33). Therefore, it can be sufficiently (more securely) suppressed that the inch index pointer 51 of the side-fence member 33 points the index 42a of A4 size in the centimeter-size display section 42 against intention and the centimeter index pointer 52 of the side-fence member 33 points the index 41a of 8.5×11 size in the inch-size display section 41 against intention.

Further, in this embodiment, by differing the respective projecting amounts of the inch index pointer 51 and the centimeter index pointer 52 of the side-fence member 33 as described above, the inch index pointer 51 points only the inch-size display section 41 and the centimeter index pointer 52 thereof points only the centimeter-size display section 42. Thus, it can be suppressed that the respective pointers of the side-fence member 33 point the indices of the unrelated size display sections against intention only by differing the respective projecting amounts of the inch index pointer 51 and the centimeter index pointer 52. In other words, it can be suppressed by such a simple construction (as to differ the respective projecting amounts) to set the side-fence member 33 at a position different from the one corresponding to the size of sheets to be accommodated into the sheet accommodating portion 31.

Further, since the first index criterion is the inch system and the second index criterion is the centimeter system in this embodiment as described above, it can be suppressed to set the side-fence member 33 at a position unrelated to the size of sheets to be accommodated in the sheet cassette 30 provided with the indicator 36 having the respective indices based on the inch system and the centimeter system that are highly frequently used as index criteria. Particularly in the case of the sheet cassette 30 of this embodiment, an erroneous operation (setting error) in positioning the side-fence member that occurs upon pointing the index of 8.5×11 size (215.9 mm) set based on the inch system or the index of A4 size (210 mm) set based on the centimeter system can be efficiently suppressed.

The embodiment disclosed this time should be thought to be illustrative and not restrictive in all respects. The scope of the present invention is defined by the appended claims rather than by the description of the above embodiment, and all changes that fall within metes and bounds of the claims, or equivalence of such metes and bounds are embraced.

For example, the indicator 36 is provided with two size display sections, i.e. the inch-size display section 41 having the indices 41a based on the inch system and the centimeter-size display section 42 having the indices 42a based on the centimeter system in the foregoing embodiment. However, the present invention is not limited thereto, and a third size display section having indices based on a unit system other than the inch system and the centimeter system may be provided at a position (area) different from those of the inch-size display section 41 and the centimeter-size display section 42 in addition to the above two size display sections. In such a case, it is preferable to provide the side-fence member 33 with a third index pointer for pointing the third size display section of the indicator 36 in addition to the inch index pointer 51 and the centimeter index pointer 52.

Although the inch system and the centimeter system are used as index criteria for indicating the standardized sheet sizes in the foregoing embodiment, the present invention is not limited thereto and unit systems other than the inch system and the centimeter system may be used as index criteria.

Although the inventive sheet cassette is applied to the one to be mounted in a copier as one example of an image forming apparatus, the present invention is not limited thereto and application to sheet cassettes mounted in image forming apparatuses such as printers and facsimile machines is also possible.

Although the indicator 36 for defining the arranged position of the side-fence member 33 is disposed at the front right side in the sheet accommodating portion 31 and outside the movable range of the side-fence member 33 in the foregoing embodiment, the present invention is not limited thereto and another indicator for defining the arranged position of the side-fence member 34 may be disposed at a rear right side in the sheet accommodating portion 31 and outside a movable range of the side-fence member 34.

Further, in the foregoing embodiment, the inch index pointer 51 and the centimeter index pointer 52 provided at the side-fence member 33 may be differently colored. This can improve the visibility of the user to distinguish the inch index pointer 51 and the centimeter index pointer 52 (these pointers can be clearly distinguished), wherefore the position of the side-fence member 33 can be more precisely aligned with the position corresponding to the sheet size. In such a case, it is preferable to color the indices 41a of the inch-size display section 41 of the indicator 36 and the indices 42a of the centimeter-size display section 42 thereof in the same colors as the corresponding index pointers 51, 52 (“the same colors” mentioned here mean not only the completely the same colors, but also similar colors of the same hue). Since this enables the user to clearly grasp the correspondence between the respective index pointers 51, 52 of the side-fence member 33 and the indices 41a, 42a of the respective size display sections of the indicator 36, the position of the side-fence member 33 can be even more precisely aligned with the position corresponding to the sheet size. Therefore, it can be more suppressed to set the side-fence member 33 at a position different from the one corresponding to sheets to be accommodated into the sheet accommodating portion 31.

This application is based on patent application No. 2005-239107 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A sheet cassette, comprising:
a sheet accommodating portion capable of accommodating a plurality of sizes of sheets,
a side-fence member movable in conformity with the size of sheets to be accommodated into the sheet accommodating portion so as to be brought into contact with the sheets at a specified side, and
a position defining portion for defining an arranged position of the side-fence member in correspondence with the size of the sheets,
the position defining portion including at least a first size display section having indices set based on a first index criterion, and a second size display section having indices set based on a second index criterion different from the first index criterion, the first and second size display sections being arranged at different positions, and
the side-fence member including a first pointer for indicating the indices of the first size display section and a second pointer for indicating the indices of the second size display section.

2. A sheet cassette according to claim 1, wherein:
the position defining portion is disposed in the proximity of an end of the side-fence member with respect to a direction normal to a moving direction of the side-fence member,
the second size display section is arranged at a side closer to the side-fence member than the first size display section,
the first pointer projects by a specified amount toward the position defining portion from the end of the side-fence member, and
the second pointer is disposed at a position spaced apart by a specified distance from the first pointer in the moving direction of the side-fence member and projects by an amount smaller than the projecting amount of the first pointer toward the position defining portion from the end of the side-fence member.

3. A sheet cassette according to claim 1, wherein the first index criterion is an inch system and the second index criterion is a centimeter system.

4. A sheet cassette according to claim 1, wherein the first and second pointers are differently colored.

5. A sheet cassette according to claim 1, wherein the first pointer and the first size display section are colored in the same first color and the second pointer and the second size display section are colored in the same second color different from the first color.

6. An image forming apparatus, comprising:
a main body, and
a sheet cassette to be mounted into the main body, wherein:
the sheet cassette includes a sheet accommodating portion capable of accommodating a plurality of sizes of sheets,
a side-fence member movable in conformity with the size of sheets to be accommodated into the sheet accommodating portion so as to be brought into contact with the sheets at a specified side, and
a position defining portion for defining an arranged position of the side-fence member in correspondence with the size of the sheets,
the position defining portion including at least a first size display section having indices set based on a first index criterion, and a second size display section having indices set based on a second index criterion different from the first index criterion, the first and second size display sections being arranged at different positions, and
the side-fence member including a first pointer for indicating the indices of the first size display section and a second pointer for indicating the indices of the second size display section.

7. An image forming apparatus according to claim 6, wherein:
the position defining portion is disposed in the proximity of an end of the side-fence member with respect to a direction normal to a moving direction of the side-fence member,
the second size display section is arranged at a side closer to the side-fence member than the first size display section,
the first pointer projects by a specified amount toward the position defining portion from the end of the side-fence member, and
the second pointer is disposed at a position spaced apart by a specified distance from the first pointer in the moving direction of the side-fence member and projects by an amount smaller than the projecting amount of the first pointer toward the position defining portion from the end of the side-fence member.

8. An image forming apparatus according to claim 6, wherein the first index criterion is an inch system and the second index criterion is a centimeter system.

9. An image forming apparatus according to claim 6, wherein the first and second pointers are differently colored.

10. An image forming apparatus according to claim 6, wherein the first pointer and the first size display section are colored in the same first color and the second pointer and the second size display section are colored in the same second color different from the first color.
